(19) United States
(12) Patent Application Publication
(10) Pub. No.: US 2007/0068329 A1
(43) Pub. Date: Mar. 29, 2007

(54) Curette system

(76) Inventors: Christopher U. Phan, San Leandro, CA (US); Meera Sankaran, Cupertino, CA (US); Alberto Ruiz Cantu, San Francisco, CA (US); Richard W. Layne, Phoenix, AZ (US)

Correspondence Address: FISH & RICHARDSON P.C., PO BOX 1022, MINNEAPOLIS, MN, 55440-1022, US

(21) Appl. No.: 11/483,406

(22) Filed: Jul. 6, 2006

Related U.S. Application Data
(60) Provisional application No. 60/698,408, filed on Jul. 11, 2005.
(60) Provisional application No. 60/698,354, filed on Jul. 11, 2005.
(60) Provisional application No. 60/756,677, filed on Jan. 6, 2006.

(51) Int. Cl. G05G 1/10

(52) U.S. Cl. 74/543

(57) ABSTRACT

A method and apparatus for creating or enlarging a cavity in a patient's body are provided. One implementation of the apparatus includes a head, a pushrod and a handle. The head is rotatable about a first axis and is configured to effectuate a medical procedure. The pushrod is attached at a distal end to the head and attached at a proximal end to a handle. The pushrod is configured to translate along a second axis substantially perpendicular to the first axis, where translation of the pushrod along the second axis rotates the head about the first axis. The handle includes a lever coupled at one first end to the pushrod and pivoting the lever about the third axis translates the pushrod along the second axis.

### CROSS REFERENCE TO RELATED APPLICATIONS

This application claims priority to: pending U.S. Provisional Application Ser. No. 60/698,408 entitled “Curette Heads”, filed on Jul. 11, 2005; pending U.S. Provisional Application Ser. No. 60/698,354 entitled “Curette System”, filed on Jul. 11, 2005; and pending U.S. Provisional Application Ser. No. 60/756,677 entitled “Curette System”, filed on Jan. 6, 2006, the entire contents of which applications are hereby incorporated by reference.

### TECHNICAL FIELD

This invention relates to medical methods and apparatus.

### BACKGROUND

When cancellous bone becomes diseased, for example, because of osteoporosis, avascular necrosis or cancer, the diseased bone may no longer provide adequate support to the surrounding cortical bone. The cortical bone may therefore become more prone to compression fracture or collapse. Similarly, healthy but damaged bone, for example, due to a traumatic fracture, may also be prone to further compression fracture or collapse.

The creation of cavities or voids within a structure (e.g., bone) in a subject can facilitate diagnostic or therapeutic intervention where disease or damaged bone is present. A curette is a surgical instrument used to remove tissue or growths from a body cavity and includes a curette head. The curette head can be shaped like a scoop or spoon to facilitate tissue removal or disruption.

### SUMMARY

This invention relates to a method and apparatus for creating a cavity in a patient's body. In general, in one aspect, the invention features an apparatus and a method for using the apparatus, where the apparatus includes a head, a pushrod, a handle and a locking mechanism. The head is rotatable about a first axis and configured to effectuate a medical procedure. The pushrod is attached at a distal end to the head and configured to translate along a second axis substantially perpendicular to the first axis, where translation of the pushrod along the second axis rotates the head about the first axis. The handle is attached to the proximal end of the pushrod and includes a base and a lever. The lever is coupled at a rotation point on a first end thereof to the base and rotatable at the rotation point about a third axis substantially perpendicular to the second axis. The lever is coupled at the first end to the pushrod and pivoting the lever about the third axis translates the pushrod along the second axis. The locking mechanism is configured to lock the lever into one or more locked positions, where each locked position of the lever corresponds to a locked position of the head.

Implementations of the invention can include one or more of the following features. The locked positions for the head can range from substantially 0 to 90 degrees relative to the second axis. The locking mechanism can be included in the handle and include a ratchet mechanism within the base, and a linking member coupled at a first end to the ratchet mechanism and at a second end to a second end of the lever. Rotation of the lever about the third axis advances the ratchet mechanism into one or more positions and locks the lever into one or more locked positions. In one implementation, the ratchet mechanism includes a latch and a slide link including one or more teeth. The teeth are configured to mate with one or more corresponding grooves included in the latch, and the latch includes one or more grooves configured to mate with the teeth. One or more of the teeth can be configured to mate with the one or more grooves in a plurality of positions including an initial position and one or more extended positions, where at least one position corresponds to a locked position of the lever.

The apparatus can further include an extension spring coupled between one end of the slide link and a proximal end of the base. The extension spring loads the teeth against corresponding grooves of the latch. The base can further include a release, the release operable to engage the latch to effectuate release of the latch from the slide link so that the extension spring may reposition the slide link into an alternate position closer to the initial position.

In one implementation, the first axis is substantially perpendicular to the third axis, and in an alternative implementation, the first axis is substantially parallel to the third axis. The pushrod can include at the distal end a cam for coupling the pushrod to the head. The head can include a tapered trunk and a disc attached to a distal end of the tapered trunk, where the disc has a dome-shaped upper surface and has a substantially 360 degree cutting surface formed about a circumference of the disc.

In general, in another aspect, the invention features an apparatus and method for using the apparatus, where the apparatus includes a head, a pushrod, a handle and a locking mechanism. The head includes one or more cutting portions and is attached at a proximal end to the pushrod. The pushrod is attached at a proximal end to the handle and is configured to translate along a first axis, where translation of the pushrod along the first axis translates the head along the first axis. The handle includes a base and a lever coupled at a rotation point on a first end thereof to the base and rotatable at the rotation point about a second axis substantially perpendicular to the first axis. The lever is coupled at the first end to the pushrod and pivoting the lever about the second axis translates the pushrod along the first axis. The locking mechanism is configured to lock the lever into one or more locked positions, where each locked position of the lever corresponds to a locked position of the head.

Implementations of the invention can include one or more of the following features. At least a portion of the head can be formed from a shape memory material, such that at a first temperature the portion of the head is in a compact position and at a second different temperature the portion of the head deploys to a cutting position, where the head is configured to cut upon translation and/or rotation of the pushrod. The head can include a set of three or more fingers and the one or more cutting portions can be at least a portion of each of the fingers that is configured for cutting or scraping. Each finger can include a proximal and distal end and the distal ends of at least two of the fingers can be interconnected. In one implementation, at least one finger is not interconnected at the finger's distal end to another finger.

The cutting portion of at least one of the three or more fingers can include a portion having a configuration selected from the group consisting of: round coin-ended, rectangular coin-ended, curve-ended, multiple curve-ended, turn-ended, flattened coil-ended, flattened loop-ended, bent and coin-ended, coil-ended, bent coil-ended, hour glass coil-ended, osteotome-ended, whisk-ended, barb-ended, multiple curve-ended, hook-ended, sharp-ended, hair pin loop ended, bent-ended, press fit-ended, sickle ended, curved cannula-ended, crown-ended, mace-ended, helicopter ended, crisscross-ended, shovel-ended and multi-windowed tube-ended.

Translating the pushrod can deploy the three or more fingers from a substantially collinear geometry to a substantially non-collinear geometry in relation to the first axis.

Using either of the apparatus described above can include establishing an access path to a location in a patient's body and introducing the head of the apparatus through the access path to the location. The lever of the apparatus can be pivoted to translate the pushrod thereby rotating and/or translating the head. Establishing the access path to the location can include inserting a cannula into the patient to the location where the cannula includes a lumen configured to receive the medical device. The head can be used to cut and/or scrape to create or enlarge a cavity at the location within the body.

Other implementations are possible. Implementations of the invention can realize one or more of the following advantages. The lever style handle on the curette system provides a mechanical advantage, allowing a user to exert enough force to position the curette head within a bone structure by comfortably squeezing the handle. The handle is ergonomic and can include features to prevent slippage in the user's hand. The handle can be designed to include as many or as few locking positions of the curette head as desired. Alternatively, the handle can be used without locking positions of the curette head. Should the shaft break at a safety groove, the pushrod is prevented from moving relative to the handle, and the risk of the pushwire at the distal end of the pushrod connecting to the head becoming wound is eliminated.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a perspective view of a curette system.

FIG. 2 shows an enlarged view of a curette head.

FIG. 3 shows an open side view of the handle of the curette system of FIG. 1.

FIG. 4 shows a side view of the handle of the curette system of FIG. 1.

FIG. 5 shows an open side view of an alternative handle of the curette system of FIG 1.

FIG. 6 shows a partial cross-sectional view of the handle shown in FIG. 5 along line A-A.

FIGS. 7-28 show various implementations of a curette head.

Like reference symbols in the various drawings indicate like elements.

### DETAILED DESCRIPTION

An apparatus and method is described for creating a cavity or cutting and/or disrupting tissue in a patient's body. For illustrative purposes, the apparatus and method shall be described in the context of creating a cavity in bone, however it should be understood that the apparatus and methods can be used to create voids in other parts of the body and to effectuate various medical procedures.

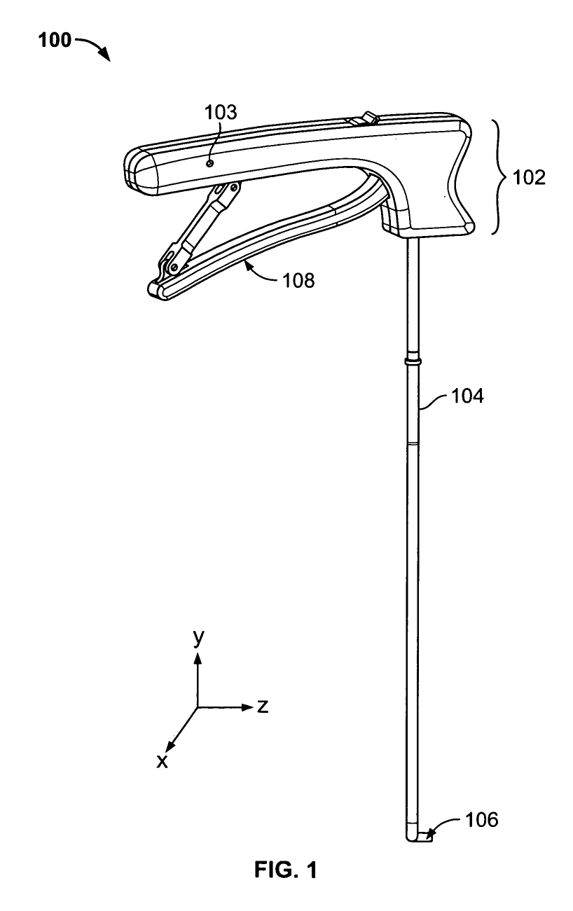

FIG. 1 shows a perspective view of a curette system 100. The curette system 100 includes a handle 102, a shaft 104 and a head 106. The handle 102 includes a lever 108 and a base 103. The lever 108 is configured to be squeezed by a user toward the base 103. Squeezing the lever 108 and base 103 rotates the lever 108 in a clockwise direction. Rotating the lever 108 causes a pushrod positioned within the shaft 104 to translate within the shaft 104 in a direction (i.e., the y direction in the orientation shown), as shall be described in further detail below.

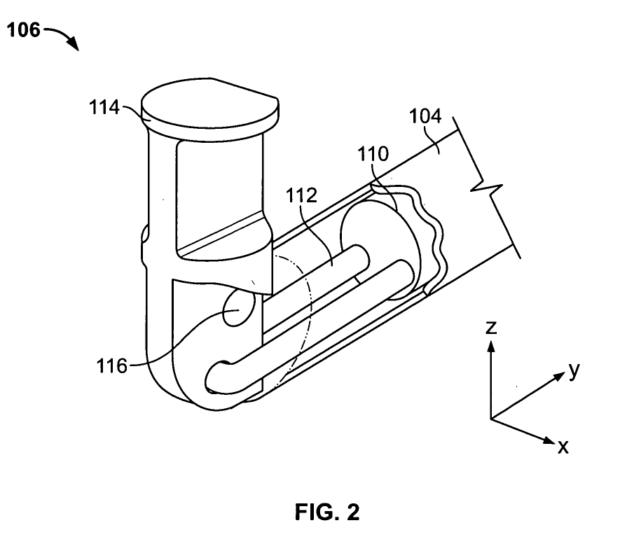

Referring to FIG. 2, an enlarged view of the head 106 is shown, with the distal end of the shaft 104 partially cut away for illustrative purposes. The distal end of the pushrod 110 is shown attached to a pushwire 112. The pushwire 112 loops through the curette tip 114. The curette tip 114 is rotatable about rotation point 116. A pin (not shown) passes through the distal end of the shaft 104 and through the curette tip 114 (e.g., at rotation point 116), to hold the proximal end of the curette tip 114 in place relative to the shaft 104. Translation of the pushrod 110 in the y direction causes the curette tip 114 to rotate about the rotation point 116, i.e., about an axis in the x direction. The direction of rotation (i.e., the x direction) is substantially perpendicular to the direction of translation of the shaft 104 (i.e., the y direction). In another implementation the curette tip 114 can rotate about a different axis (i.e., the z-axis) if configured such that the pin connecting the curette tip 114 to the shaft 104 is aligned with the different axis (rather than the x-axis as shown). In yet another implementation, the shaft 104 can be rotated or torqued, causing rotation of the curette tip 114.

In one implementation, a working cannula is inserted into a patient's body such that a distal end of the cannula is positioned where a cavity is to be created. The curette system 100 is inserted into the cannula. During insertion through the cannula, the curette tip 114 is axially aligned with the shaft 104 to minimize the required interior diameter of the cannula (i.e., the initial position). Once the head 106 of the curette system 100 has cleared the cannula and is positioned within the patient's body at a location where a cavity is to be created, the curette tip 114 can be rotated into an extended position, e.g., rotated 90° to the position shown in FIG. 2. The curette tip 114 can then be operated as a scoop or scraping instrument by the user by turning, pulling and pushing the curette system 100.

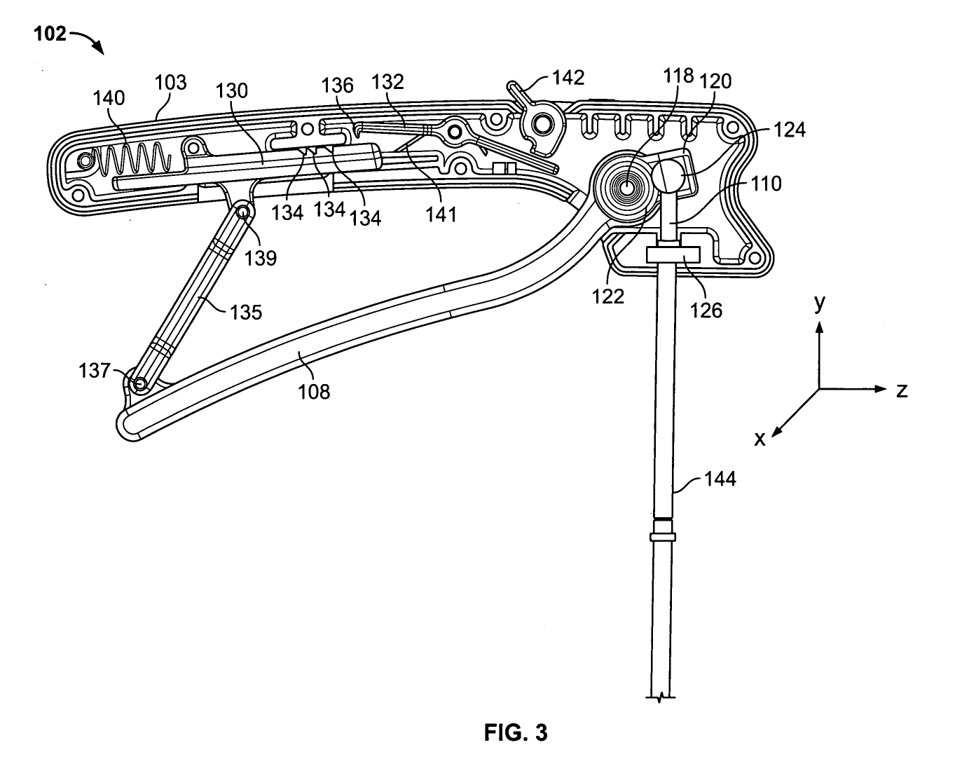

Referring to FIG. 3, an open side view of one implementation of the handle 102 of the curette system 100 is shown. As described above, the handle 102 includes a base 103 and a lever 108. The lever 108 is rotatable about fulcrum point 118 in the proximal region of the lever 108. In this implementation, the lever's proximal end 120 includes a cavity 122 configured to receive a ball joint 124 attached to a proximal end of the pushrod 110. Rotating the lever 108 about the fulcrum point 118, i.e., about the x-axis, rotates the lever's proximal end 120. As the lever 108 is squeezed closed by a user, the lever's proximal end 120 rotates clockwise, causing the ball joint 124 to translate, i.e., downwardly in the y direction. Translation of the ball joint 124 in the y direction causes the pushrod 110 to translate in the y direction. The ball joint 124 is one implementation of a coupling between the pushrod 110 and the lever 108. The coupling can have other configurations. Generally, the joint should mimic the shape of the cavity 122, e.g., a square shape, a star shape, a triangular shape, etc. As described above in reference to FIG. 2, translating the pushrod 110 rotates the curette tip 114. The pushrod 110 is prevented from moving laterally (e.g., in the x and z directions as shown in FIG. 3) by a flange 126 attached to the outer shaft and keyed into the base 103 of the handle 102.

A ratchet mechanism can be included in the base 103 of the handle 102 to provide one or more locked positions of the lever 108, and therefore one or more extended positions of the curette tip 114. In one implementation, the ratchet mechanism includes a slide link 130 and a latch 132. In one implementation, the slide link 130 includes three grooves 134 and the latch 132 includes at least one corresponding tooth 136, though other configurations are possible. For example, without limitation, other configurations can include a pawl and gear system located at the fulcrum point, where the gear rotates with the lever and the pawl prevents counter rotation unless disengaged. A catch and latch locking mechanism could also be used, for example, located at the fulcrum point 118. Referring again to the mechanism shown, each groove 134 is configured to receive the (a) tooth 136 from the latch 132. Each groove 134 and the (a) tooth 136 can have angled faces as shown to facilitate engaging and disengaging the (a) tooth 136 from a groove 134.

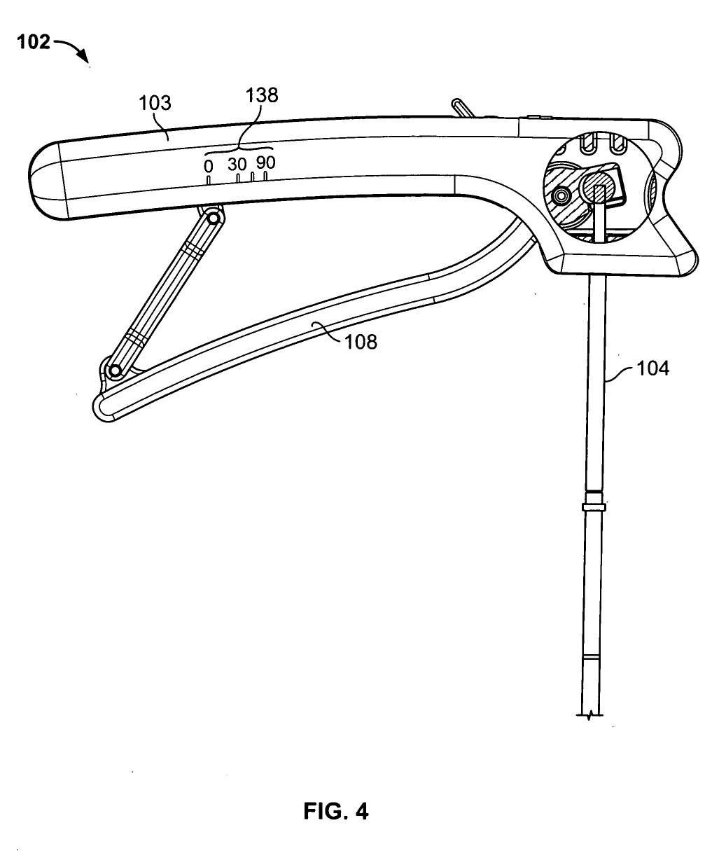

Referring to FIG. 4, a side view of the handle 102 is shown. In one implementation, markings 138 can be included on the base 103 of the handle 102. Each marking 138 can correspond to a locked position of the lever 108, and indicate the angle of the curette tip 114 when the lever 108 is in the locked position. For example, the lever 108 is shown at position “0” meaning the angle of the curette tip 114 is 0°, therefore the curette tip 114 is in the initial position, axially aligned with the shaft 104. The next marking 138 indicates an angle of 30°, meaning when the lever 108 is locked in this position by moving the (a) tooth 136 into a predetermined groove (i.e., the next groove) 134, the curette tip 114 in an extended position is at angle of approximately 30° from the y-axis. The next marking 138 is unmarked, but can correspond to an angle of 60°, and the final marking 138 can correspond to an angle of 90°. The user can squeeze the lever 108 to move the lever 108 between the locked positions and advancing the slide link 130 such that the (a) tooth 136 on the latch 132 engages with different grooves 134 included in the slide link 130. In other implementations, more or fewer locked positions of the lever 108 can be included, corresponding to more or fewer extended positions of the curette tip 114.

Alternatively, the tip 114 can be articulated without locking into one or more positions. For example, a rapid-fire type squeezing motion of the lever 108 can be used to articulate the tip 114, where the release 142 is in the unlocked, back position (see FIGS. 1 and 3) and prevented from engaging the latch 132.

Referring again to FIG. 3, the handle 102 further includes an extension spring 140 coupled between one end of the slide link 130 and a proximal end of the base 103. The extension spring 140 loads a groove 134 against the tooth(teeth) 136 of the latch 132. The base 103 further includes a release 142, the release 142 operable to engage the latch 132 to effectuate release of the latch 132 from the slide link 130 so that the extension spring 140 may reposition the slide link 130 into an alternate position closer to the initial position of the lever 108 and corresponding initial position of the curette tip 114. A flexure 141 can urge the latch 132 into engagement with the slide link 130 when the release is in an inactive position as shown. A linking member 135 couples a distal end of the lever 108 to the base 103 about rotation points 137 and 139.

The curette system 100 includes a safety feature designed to prevent the curette head 106 from breaking off while within a patient, for example, if subjected to torque. Referring again to FIG. 3, the shaft 104 includes a safety groove 144. The safety groove 144 is designed to provide a weakened region of the shaft 104, such that the shaft 104 will fail when subject to excessive torque before the curette head 106 will fail. That is, less force is required to break the shaft 104 at the safety groove 144 then can cause the curette head 106 to fail, for example, by breaking off. Typically, a situation that may cause failure of the shaft 104 is forcing the curette tip 114 against a particularly hard structure, e.g., bone, that is not easily scraped or scooped by the curette tip 114. Failing of the shaft 104 provides an indication to the user to cease the activity and withdraw the curette system 100 from the patient. If the user does not immediately realize the shaft 104 has failed, the user may continue to squeeze the lever 108 and attempt to rotate the curette tip 114. Because the pushrod 110 is coupled to the handle 102 by the ball joint 124, the pushrod 110 will only translate in the y direction, and will not rotate about the y axis. That is, rotating the handle will not rotate the pushrod 110, as the ball joint 124 will just rotate within the cavity 122. This configuration ensures that the pushwire 112 will not wind around the pushrod 110 and/or curette head 106 causing the curette tip 114 to end up fixed in an extended position, and therefore impossible to retract through the cannula.

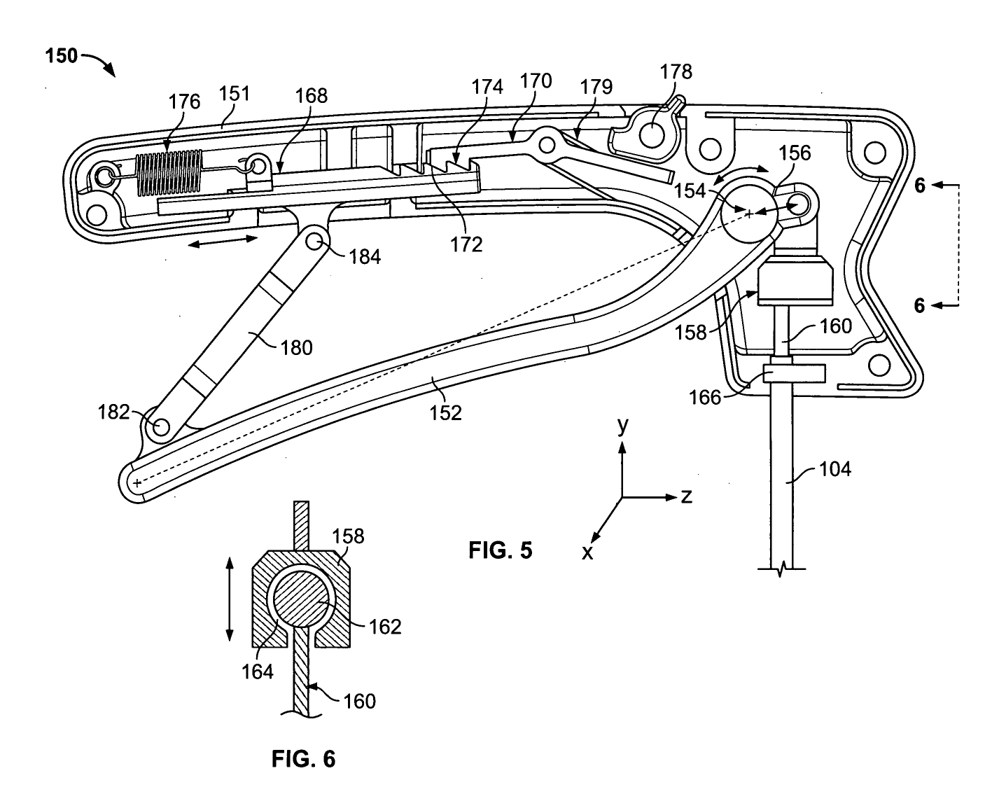

Referring to FIG. 5, an open side view of another implementation of a handle 150 of the curette system 100 is shown. The lever 152 is rotatable about fulcrum point 154 in the proximal region of the lever 152. In this implementation, the lever's proximal end 156 is connected to a shaft link 158, e.g., by a pin. The shaft link 158 is connected to a pushrod 160. Rotating the lever 152 about the fulcrum point 154, i.e., about the x-axis, rotates the lever's proximal end 156. As the lever 152 is squeezed closed by a user, the lever's proximal end 156 rotates clockwise, causing the shaft link 158 to translate (i.e., downwardly in the y direction). Translation of the shaft link 158 in the y direction causes the pushrod 160 to translate in the y direction. As described above in reference to FIG. 2, translating the pushrod 160 rotates the curette tip 114.

Referring to FIGS. 5 and 6, a cross-sectional view of a portion of the handle 150 taken along line A-A is shown in FIG. 6. In this implementation, the pushrod 160 has a cylindrical proximal end 162 that fits within a cavity 164 formed inside the lower portion of the shaft link 158. The upper portion of the shaft link 158 is connected to the lever's proximal end 156. As the shaft link 158 translates in the y direction, the cylindrical proximal end 162 of the pushrod 160 moves with the lower portion of the shaft link 158, passing the translation movement in the y direction from the shaft link 158 to the pushrod 160. The proximal end of the shaft 104 is shown secured within a flange 166. The pushrod 160 extends through the shaft 104. The flange 166 fixes the shaft 104, and therefore the pushrod 160, laterally relative to the handle 150 (the shaft link 158 can translate slightly in the z-direction).

Referring again to FIG. 5, a ratchet mechanism can be included in the handle 150 to provide one or more locked positions of the lever 152, and therefore one or more extended positions of the curette tip 114. In the implementation shown, the ratchet mechanism includes a slide link 168 and a latch 170. The slide link 168 includes four teeth 172. The latch 170 includes at least one corresponding groove 174. The groove 174 is configured to receive a tooth 172 from the slide link 168. The groove 174 and teeth 172 can have angled faces as shown to facilitate engaging and disengaging a tooth 172 from the groove 174. Other configurations of teeth and grooves are possible.

The handle 150 further includes an extension spring 176 coupled between one end of the slide link 168 and a proximal end of the base 151. The extension spring 176 loads a tooth(teeth) 172 against a corresponding groove(s) 174 of the latch 170. The base 151 further includes a release 178, the release 178 operable to engage the latch 170 to effectuate release of the latch 170 from the slide link 168 so that the extension spring 176 may reposition the slide link 168 into an alternate position closer to the initial position of the lever 152, and corresponding initial position of the curette tip 114. A linking member 180 couples a distal end of the lever 152 to the base 151 about rotation points 182 and 184.

The handles 102 and 150 can be configured to ergonomically complement a user's hand, and can include padding or other such material strategically positioned to prevent slippage within the user's hand and enhance gripping of the lever 108 and base 103.

In operation, in one implementation, a user may begin using the handle 102 or 150 in an unlocked mode unless hard bone is encountered. Using image guidance, the user can place the tip 114 through an access cannula and into contact with the desired treatment area (e.g., bone, disc, tissue, tumor, etc.), and squeeze the handle 102 or 150 to articulate the tip 114 to a desired angle. Using image guidance, the user can carefully score the treatment area, for example, using a thrust and pull motion. The user may adjust the angle of the tip 114 and repeat as necessary. If the bone is soft, the user will be able to easily articulate the tip 114 to create a void. The user may freehand the tip 114 to the fully articulated position (e.g., 90°) without activating the locking mechanism, while comfortably maintaining the tip 114 in its fully articulated position by maintaining a firm, closed grip on the handle 102 or 150. It should be noted that the tip 114 can be articulated solely with the handle/trigger mechanism, and the curette system 100 can be translated along the y-axis in a back-and-forth thrust and pull motion. The system 100 can also be rotated in the x-z plane and in a combination of all these movements, e.g., articulating the tip 114, moving the system 100 back-and-forth and side-to-side.

The user can rely on tactile feedback (e.g., resistance to bone movement) and image guidance to know when hard bone is encountered, for example, the outer cortical shell or healed bone (sclerotic). When the user encounters hard bone, the user may choose to use preset tip 114 deployment modes (i.e., locked positions) to initiate making a void along a fracture line. This can allow for a controlled, gradual opening of the cavity. Using image guidance, the user can place the tip 114 through the access cannula and into contact with the desired treatment area and begin actuating the handle 102 or 150. On encountering resistance to deployment of the tip 114, the user can switch the release 142 into the locking position. Resistance by the bone to the tip 114 allows for the lever 108 to be slowly closed by the user and into the first locked position. The user can then score the hard bone in a thrust and pull motion and/or sweeping motion to break up and/or dislodge or disrupt the sclerotic bone. If desired, the user can then continue to engage the lever 108 under image guidance to further engage the second and additional locked positions until the cavity is fully opened or created. The release 142 can then be unlocked and the tip 114 returned to alignment with the shaft (i.e., 0°) and the system 100 removed. In one implementation, another tool, for example, a balloon or longer curette, can then be further used to achieve optimal cavity creation and/or fracture reduction. Modified or other techniques for using the curette system 100 to create a void or disrupt tissue can be used. For example, techniques described in U.S. Pat. No. 6,923,813, entitled “Devices for Creating Voids in Interior Body Regions and Related Methods”, granted to Phillips et al, on Aug. 2, 2005, and assigned to Kyphon, Inc., the entire contents of which are hereby incorporated by reference, and described in U.S. patent application Ser. No. 10/893,155, entitled “Devices for Creating Voids in Interior Body Regions and Related Methods”, filed Jul. 16, 2004, by Layne et al, the entire contents of which are also hereby incorporated by reference, can be used.

The curette system 100 described above can be used with any configuration of curette head 106 and curette tip 114. The curette head 106 shown in FIG. 2 is an exemplary head 106 and was described for illustrative purposes. Other forms of curette heads 106, for example, those described in U.S. patent application Ser. No. 10/893,155, entitled “Devices for Creating Voids in Interior Body Regions and Related Methods”, filed Jul. 16, 2004, by Layne et al,.

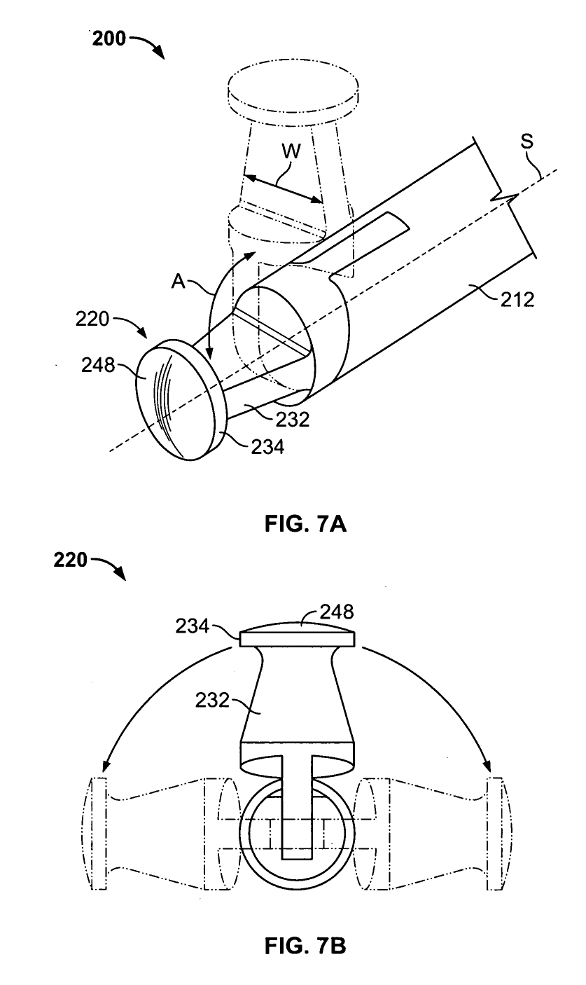

For further illustrative purposes, a number of different implementations of curette heads 106 that can be used in the curette system 100 are described below. FIGS. 7A and 7B illustrate an alternative embodiment of a curette head 200 for creating voids in interior body regions. In this embodiment, the trunk 232 is tapered and rotated 90° relative to the embodiment shown in FIG. 2 so that the maximum width W of the trunk is perpendicular to the axis S of the shaft 212 when the tip 220 is deployed at a 90° angle A from the axis S of the shaft 212. This arrangement minimizes the combined surface area of the disc 234 and trunk 232 in contact with the bone during scraping and cutting and thus minimizes transmission of significant force and stress to the hinge mechanism.

The disc 234 has a convex front surface 248 providing a dome-shape. Preferably, the disc 234 has a diameter that is approximately the same as the diameter of the shaft 212, minimizing stress on the tip 220 during cutting and providing ease of passage of the tip 220 through a cannula. The domed configuration facilitates cutting and scraping of bone by producing leverage on the bone that allows the tip 220 to roll out of the bone easily. The domed configuration allows the tip to easily release from bone and to disengage from the bone for easy withdrawal. The disc 234 provides a 360° cutting surface and permits both translational and rotational movement of the cutting disc 234 when deployed at the desired angle A, as previously described.

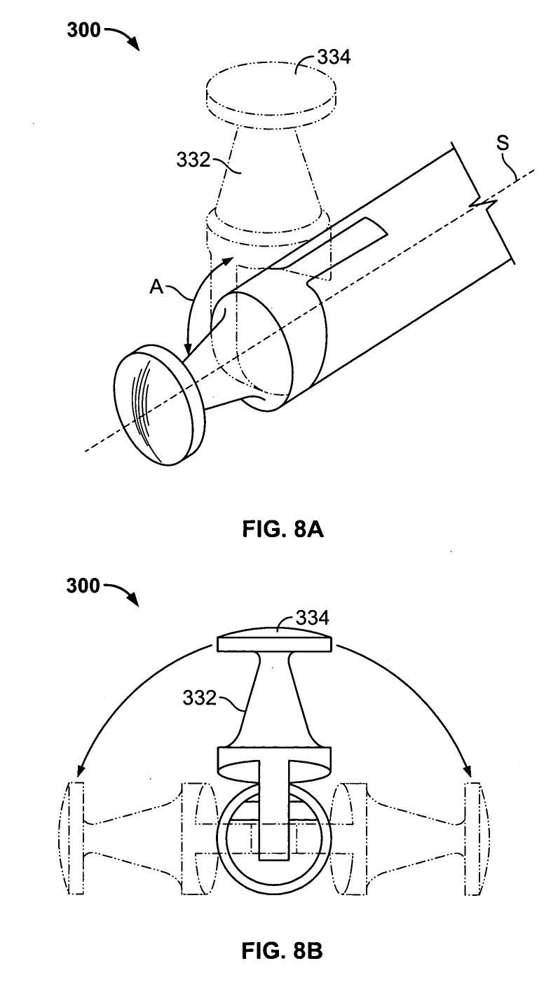

FIGS. 8A and 8B illustrate another alternative embodiment of a curette head 300 for creating voids in interior body regions. The curette tip includes a cutting disc 224 and a trunk 332. In this embodiment, the trunk 332 is tapered similar to the embodiment of FIGS. 7A and 7B, but is conical. The trunk 332 also carries a dome-shaped disc 334 allowing both translational and rotational cutting, similar to the embodiment of FIGS. 7A and 7B.

The combined cutting surface of the disc 334 and trunk 332 is minimized and is designed to reduce the force and stress on the hinged mechanism by minimizing the contact area in the bone in all directions. The same profile (symmetrical cross-section of the conical trunk 332) is presented to the bone regardless of whether pushing or pulling (translational) force, turning (rotational) force, or a combination of both forces is applied.

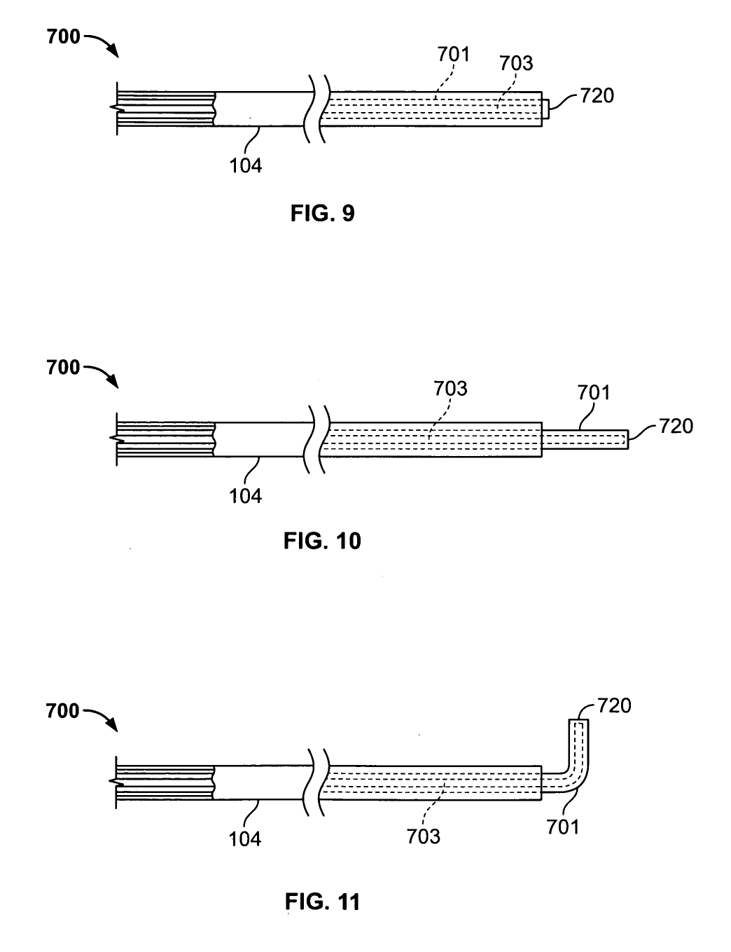

FIGS. 9-11 illustrate an embodiment of a curette head 700 employing a curette tip 720 formed of a shape memory alloy. Use of a shape memory alloy allows for a smaller instrument as the hinge mechanism is no longer needed to activate the head. Smaller instruments are safer and can access smaller vertebral bodies located higher in the spine. Smaller instruments are also less invasive and are less traumatic to the patient, allowing for a faster recuperation time.

A malleable rod 701 formed of a shape memory alloy, e.g., Nitinol, is provided at a distal end of the pushrod 110. In this implementation, the curette tip 720 does not require rotation but does require translation in the y direction. The curette tip 720 (formed at the distal end of the pushrod 110) can be translated by translating the pushrod 110, as described above. The rod 701 may be of a variety of different diameters, head configurations, and actuation angles. The rod 701 has a malleable or straightened state (FIGS. 9 and 10) and an activated or articulated predetermined, desired state (FIG. 11).

The rod 701 is sized and configured for passage in a straightened or malleable state through a shaft 104 into a vertebra, any bone surface or other area. As described above, the shaft 104 can be inserted into a cannula already positioned in the area (e.g., bone or disc tissue). Once inserted into the area, the rod 701 returns to its predetermined, desired memory shape as a result of either the body temperature of the patient or by means of an electrical impulse (e.g., cooling, heat, voltage, etc.). For example, the distal end of the rod 701 is activated to an angle, e.g., 90°, to form an elbow defining a cutting curette tip 720, as shown in FIG. 11. In a representative embodiment, the length from the distal end of the rod to the bend is approximately 0.5 cm. Cutting of the bone can be accomplished by a rotating motion or a push-pull motion or a combination of both motions, as previously described. The rod 701 desirably includes a lumen 703 that permits introduction of a cooling or heating media (S), e.g., saline, to return the rod 701 to a straightened state allowing for easy withdrawal.

In another embodiment, the rod 701 is formed from a shape memory alloy with an activation temperature that is equal to room temperature, i.e., the rod 701 is fully austenitic at room temperature. Therefore, the rod 701 is fully articulated to its predetermined shape at room temperature. The rod 701 is chilled to a martensitic condition (malleable state) prior to insertion, allowing for easy insertion. The rod 701 articulates to the predetermined, desired position upon returning to room temperature. This ensures that the proximal end of the curette tip 720 attains full activation without depending on heat transfer from the distal end of the rod 701 (which is in contact with the patient) or any outside means (e.g., heat, voltage, etc.). A lumen 703 can provided in the rod 701 to facilitate the introduction of a cooling media (S), e.g., chilled saline, to deactivate the material and allow for easy withdrawal. In another alternative embodiment, the alloy is super-elastic and the shaft 104 confines the pre-bent or formed curette tip 720 until the pushrod 110 deploys the curette tip 720 to extend beyond the shaft 104 (see FIGS. 18 and 19).

In another alternative embodiment, the rod 701 may be used to straighten the shaft 104 which is formed of a shape memory alloy. In this embodiment, the curette tip 720 is disposed on the shape memory shaft 104 (not shown). The shaft 104 is educated to have a curved head and the rod 701 is moveably disposed within the shaft 104 to straighten the shaft 104 by fully engaging the rod 701 within the shaft 104 (i.e. by pushing the rod 701) and to allow the shaft 104 and curette tip 720 to curve or articulate by pulling back on the rod 701. Desirably, the rod 701 is made of a rigid material, such as stainless steel.

In another embodiment, the activation temperature of the alloy is set at a temperature higher than body temperature. In this embodiment, the rod 701 is malleable for insertion and withdrawal. The rod 701 achieves full activation to its predetermined shape only through the application of heat or voltage. This permits control of the change of the state of the rod 701 from malleable to the predetermined shape, or any percentage there between, using a potentiometer or other suitable device.

In one implementation the handle 102 includes a luer fitting sized and configured to mate with a complementary luer fitting on a fluid introduction device, e.g., a syringe, to establish fluid communication between the lumen 703 and the fluid introduction device. Fluid, e.g., chilled or heated saline, may be introduced from the syringe through the lumen 703 (which extends the substantially the length of the pushrod 110 as well as the rod 701) to control movement of the rod 701 between the malleable (deactivated) and activated states.

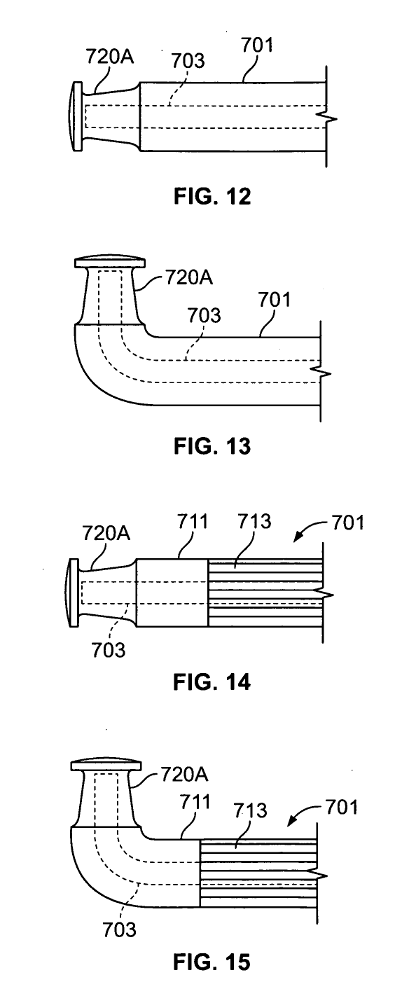

In an alternative embodiment, shown in FIGS. 12 and 13, a curette tip 720A of a desired configuration is formed at the distal end of the malleable rod 701. The malleable rod 701 is formed at the distal end of the pushrod 110. The tip 720A may be a separate piece attached (e.g., welded) to the rod 701, or the tip 720A may be carved or otherwise formed in the rod 701, e.g., by conventional machining techniques. In the illustrated embodiment, the curette tip 720A is of a conical trunk and domed disc configuration similar to the embodiment illustrated in FIGS. 17 and 18. It is apparent, however, that the configuration of the curette tip 720A can be varied according to the procedure being performed and/or to accommodate individual anatomy. In one embodiment, the entire rod 701, including the curette tip 720A, are formed of the shape memory alloy. The rod 701 yields from a malleable state (FIG. 29) to the activated state (FIG. 30) as previously described. The rod 701 and pushrod 110 can include a lumen 703 to permit introduction of a fluid media to control movement between the deactivated and activated states, as also previously described.

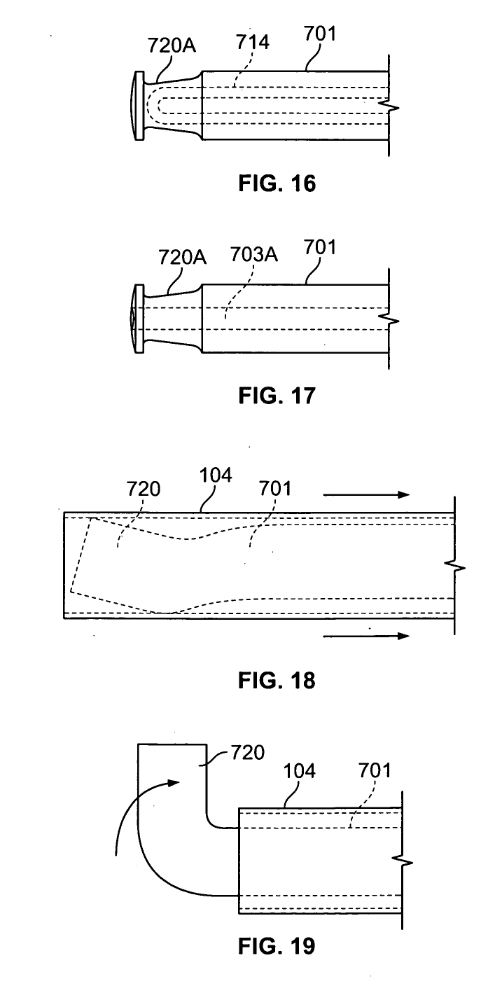

In an alternative embodiment, illustrated in FIGS. 14 and 15, the tip 720A and a distal portion 711 of the rod 701 are formed of a shape memory alloy. A rod body 713 can be formed of any suitable biocompatible, surgical grade material. The distal portion 711, carrying the curette tip 720A, is welded or otherwise fixed to the rod body 713. The distal portion 711 of the rod 701 yields from a malleable state (FIG. 14) to the activated state (FIG. 15). The rod 701 and pushrod 110 can include a lumen 703 to permit introduction of a fluid media to control movement between the deactivated and activated states. In an alternative embodiment, the pushrod 110 and rod 701 may include a dual lumen 714 so that fluid media can circulate through the pushrod 110 and desirably through the curette tip 720 (see FIG. 16) In another alternative embodiment, the pushrod 110 and rod 701 may include a throughbore 703A to accommodate more thermal flow (see FIG. 17).

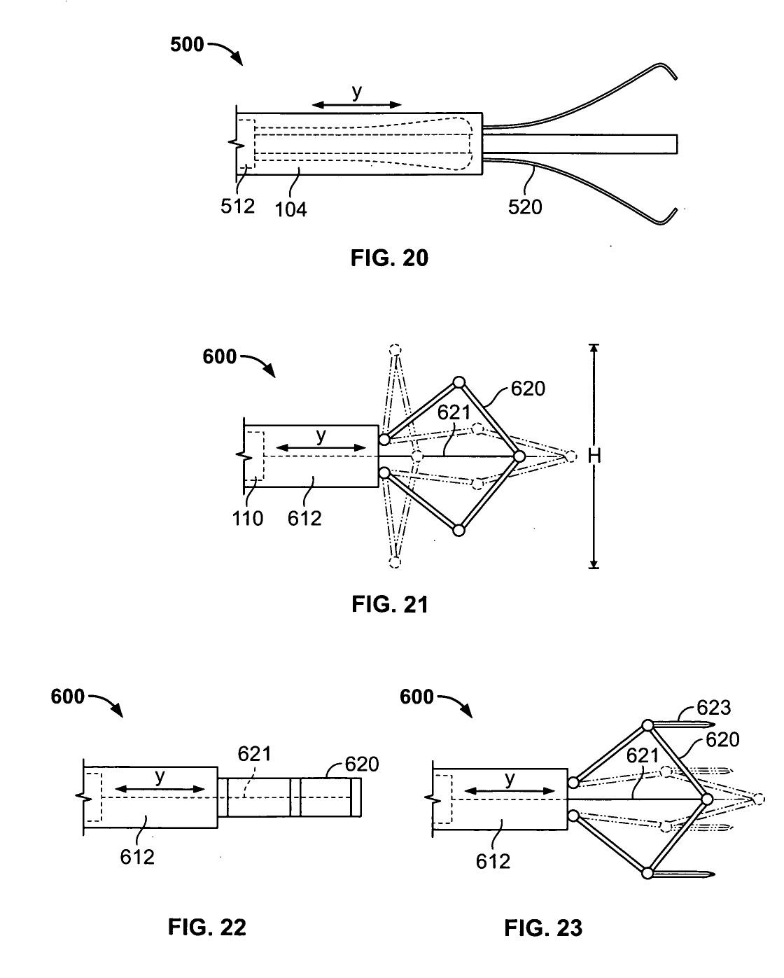

FIG. 20 shows another embodiment of a curette head 500 manipulatable, for example, for creating a void in an interior body region. The curette tip includes two or more fingers 520 carried on the distal end of the pushrod 512. Preferably, the pushrod 512 carries four fingers 520, two fingers 520 facing each other. The fingers 520 are introduced into the tissue through a cannula (not shown), and then mechanically closed with a pulley-type system or other similar system to grab tissue for extraction. By translating the pushrod 512 (i.e., in the y direction), the curette head 500 can be advanced out of the shaft 104 and into the tissue, the fingers expanding into a deployed state. Desirably, the fingers 520 are adapted to further expand as the size of the void increases. It is apparent that the length of the fingers 520 may be chosen to suit the intended use and particular individual anatomy.

FIGS. 21 and 22 show another embodiment of a curette head 600 for creating a void in an interior body region. The curette tip includes a hinged void-creating device 620 carried on the distal end of the shaft 612. The void-creating device 620 may be used to create a void or to loosen tissue to allow better cutting and removal by other mechanical tools.

The void-creating device 620 provides for adjusting the height of the device 620. A positioning rod 621 is coupled to the device 620 for expanding and contracting the device 620. The positioning rod 621 is attached to the distal end of the pushrod 110, and translates (i.e., in the y direction) with translation of the pushrod 110. The height may be adjusted by drawing in the rod 621 to increase the height H and pushing out on the rod to decrease the height H of the device 620. Drawing in and pushing out the rod 621 is achieved by squeezing the lever 108 of the handle 102 to translate the pushrod 110 (FIG. 1). Calibrated markings (not shown) may be provided on the handle 102 to indicate the dimension of the device 620 as the rod 621 is drawn back or advanced. The height H may also be chosen to suit the intended use and particular individual anatomy.

FIG. 23 shows an embodiment similar to FIGS. 21 and 22, but additionally providing a spring blade or series of spring blades 623 for more aggressive cutting. The spring blades 623 are coupled to the last blades out of the shaft 612 and desirably pre-bent to cut parallel to the end plates.

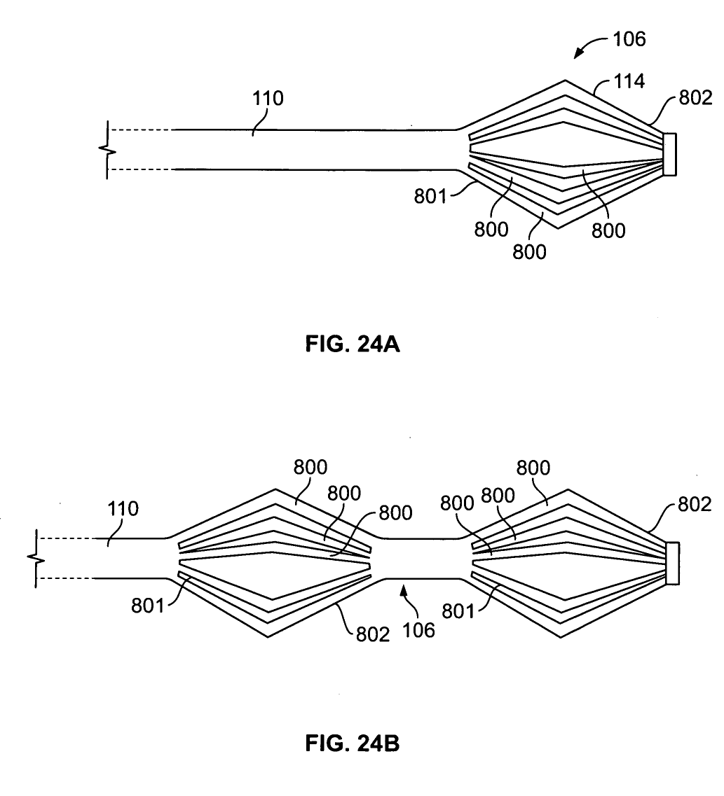

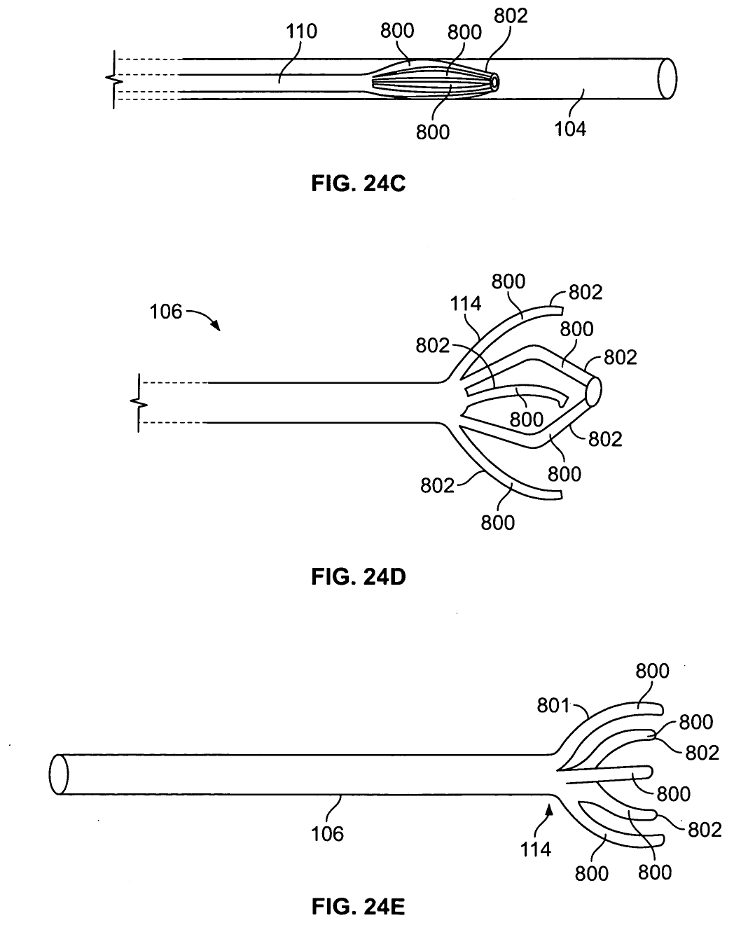

In another implementation, the curette head 106 at the distal end of the pushrod 110 can include fingers, for example, fingers 800 as shown in FIGS. 24A-E having proximal portions 801 and distal portions 802; the fingers 800 form the curette tip 114 in this implementation. The finger proximal portions 801 are connected to the distal end of the pushrod 110. The fingers 800 are arranged and configured for cutting or scraping structures of a patient. In the implementation shown in FIG. 24B, two sets of fingers 800 can be arranged in tandem to form the curette head 106 at the distal end of the pushrod 110.

In the implementations shown in FIGS. 24A-C, 26A and 27D-E each finger 800 interconnects at the finger distal portion 802 to one or more other finger distal portions 802. In another implementation, distal portion 802 of each finger 800 can be interconnected by common attachment to, for example, a ring, disc, plug, tube or other suitable attachment point.

As shown in FIG. 24D, in another implementation the curette tip can include a combination of two or more interconnected fingers 800 (i.e., fingers 800 connected at distal portion 802) and one or more other fingers where the finger distal portion 802 of the other fingers are not connected to distal portions 802 of any other fingers 800.

As shown in FIG. 24E, in a particular implementation the curette head 106 includes a shape memory metal member attached to the distal end of the pushrod 110. The shape memory metal member includes two or more deployable fingers 800 including proximal portions 801 and distal portions 802, wherein the finger's proximal portions 801 are connected to the distal end of the pushrod 110 and wherein the fingers 800 are arranged and configured for cutting or scraping. In one implementation the curette head 106 is comprised of a material such as a metal, a shape memory metal and a polymer. A metal can include, for example, cobalt-chrome (L605), ASTMf90, 304/216 spring tempered stainless steel, titanium, and nickel-titanium. A shape memory metal can include, for example, NITINOL (an acronym for Nickel Titanium Naval Ordnance Laboratory), a family of intermetallic materials, which contain a nearly equal mixture of nickel (55 wt. %) and titanium. In another implementation, other elements can be added to NITINOL to adjust or “tune” the material properties. A polymer can include, for example, polycarbonate or nylon (glass-filled).

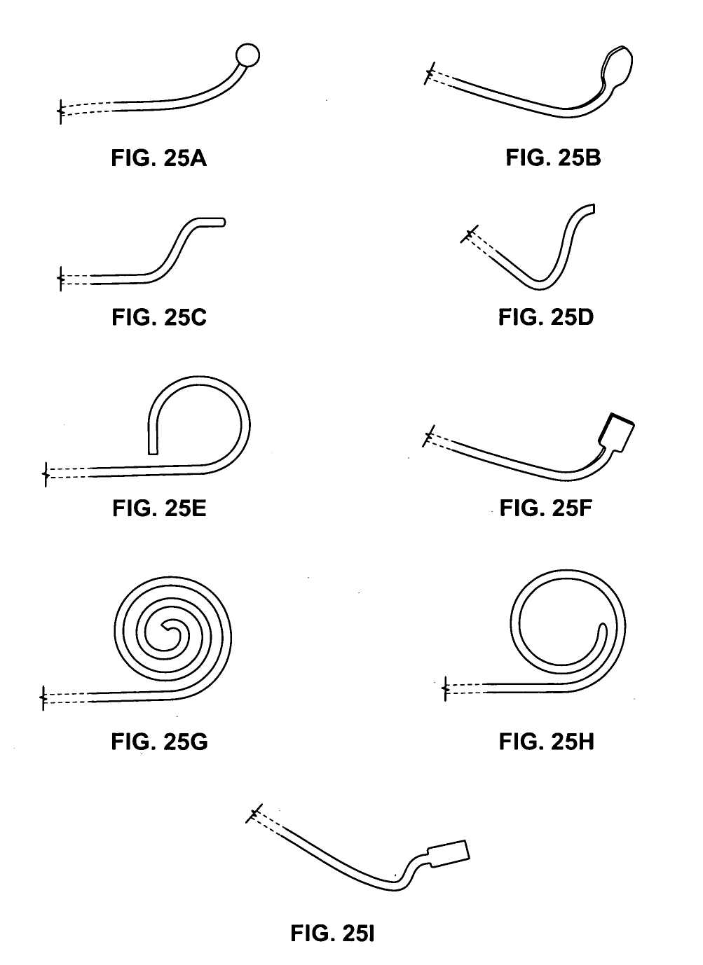

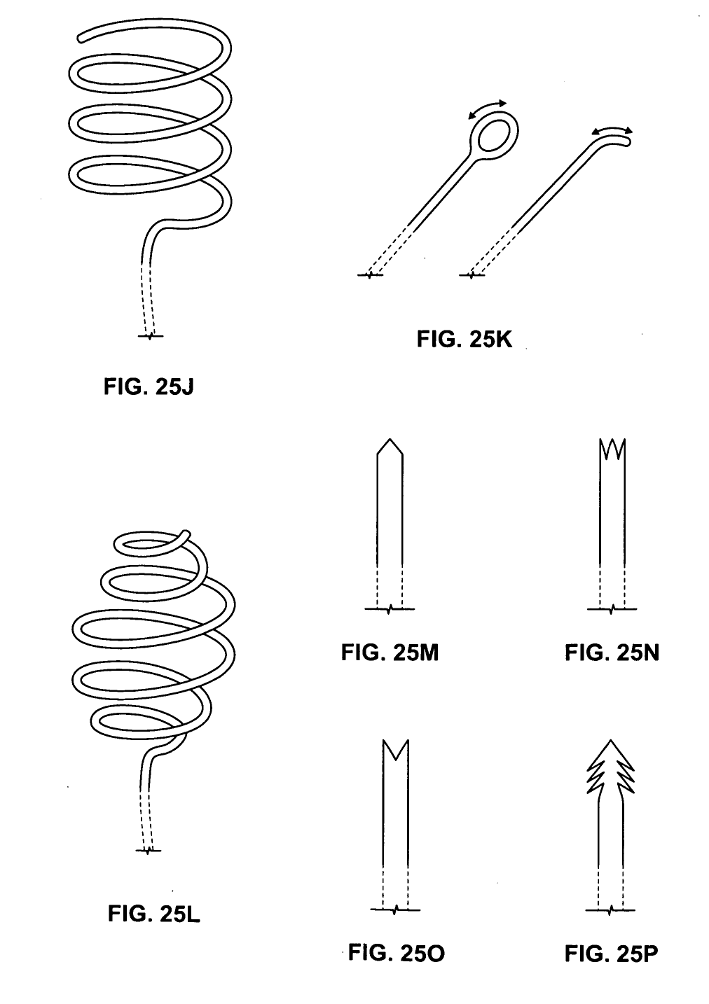

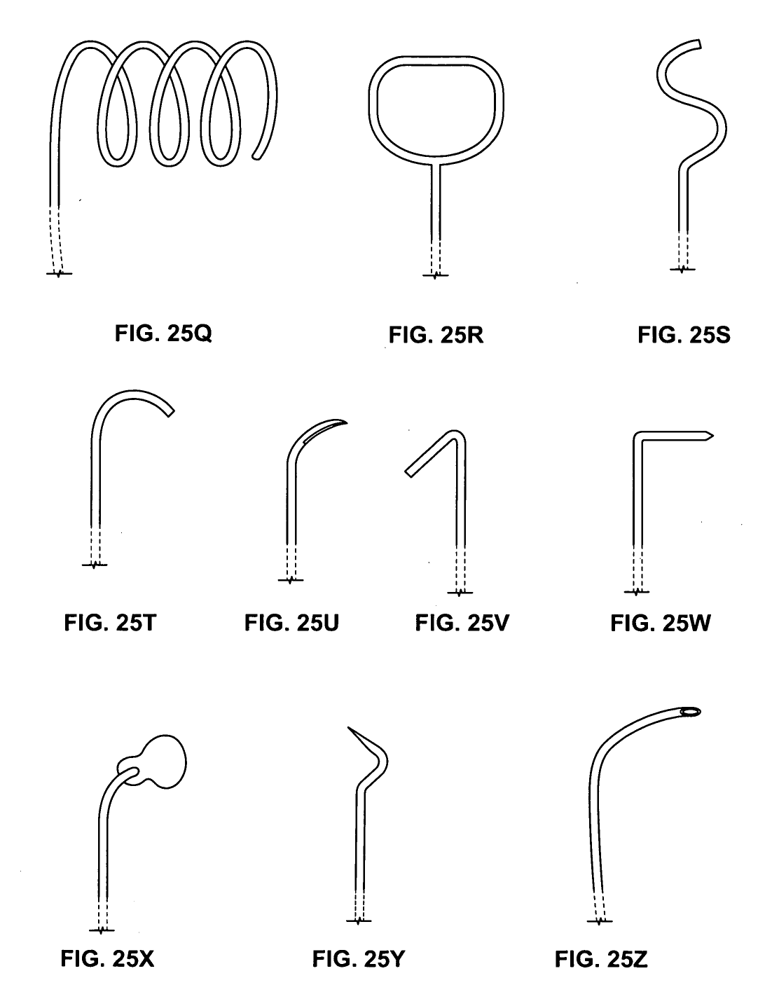

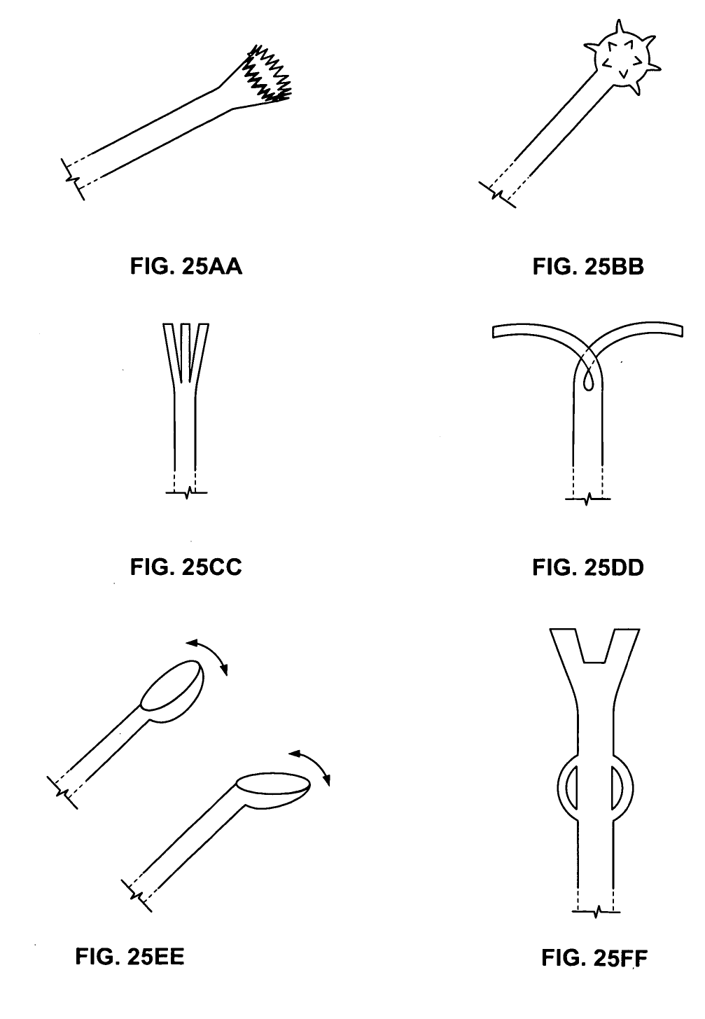

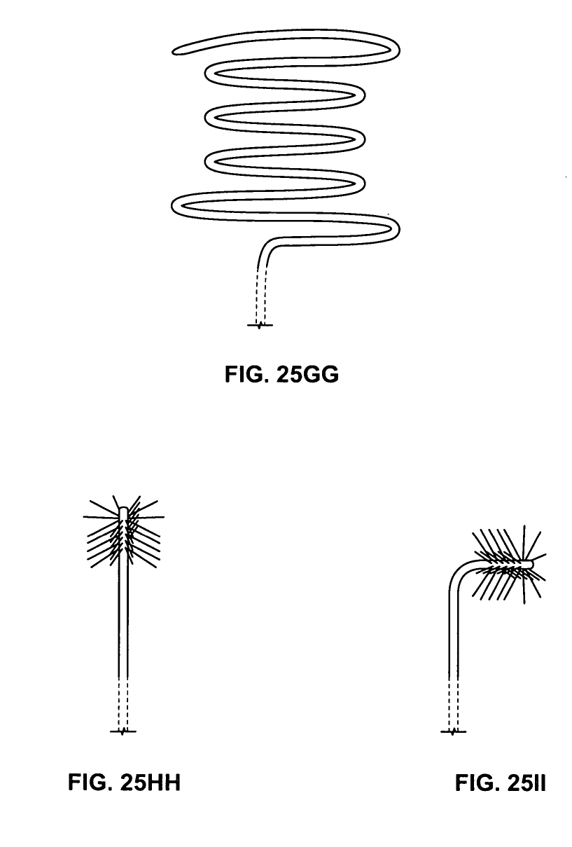

Referring to FIGS. 25A-II, the fingers 800 can include a cutting or scraping portion. Examples of suitable cutting or scraping portions include but are not limited to ball-ended (see FIG. 25A), coin-ended (see FIG. 25B), curve-ended (see FIG. 25C), turn-ended (see FIG. 25D), docking-ended (see FIG. 25E), square coin-ended (see FIG. 25F), flattened coil-ended (see FIG. 25G), flattened loop ended (see FIG. 25H), bent and coined-ended (see FIG. 25I), coil-ended (see FIG. 25J), osteotome-ended (see FIG. 25K), whisk-ended (see FIG. 25L), barb-ended (see FIGS. 25M-P), bent coil-ended (see FIG. 25Q), loop-ended, (see FIG. 25R), multiple curve-ended (see FIG. 25S), hook-ended (see FIG. 25T), sharp-ended (see FIG. 25U), hair pin loop ended (see FIG. 25V), bent-ended (see FIG. 25W), press fit-ended (see FIG. 25X), sickle ended (see FIG. 25Y), curved cannula-ended (see FIG. 25Z), crown-ended (see FIG. 25AA), mace-ended (see FIG. 25BB), helicopter-ended (see FIG. 25CC), crisscross-ended (see FIG. 25DD), shovel-ended (see FIG. 25EE), multi-windowed tube-ended (see FIG. 25FF), hourglass coil-ended (see FIG. 25GG), brush-ended (see FIG. 25HH) and bent brush-ended (see FIG. 25II).

Actuation of cutting or scraping with the fingers 800 can be achieved, for example, through a forward and back flexing movement of the fingers 800 in relation to the pushrod 110. Such a movement can be driven by a drive (e.g., hydraulic) mechanism or manually. As shown in FIG. 25K, where finger 800 cutting or scraping portion is osteotome-ended, a finger 800 can include, for example, nickel-titanium and the osteotome end can be actuated in a forward and back movement. As shown in FIG. 25CC, where the finger 800 cutting or scraping portion is helicopter-ended, the actuation of cutting or scraping can include interconversion of finger 800 from a low profile folded configuration to an unfolded configuration. As shown in FIG. 25EE, where the finger 800 cutting or scraping portion is shovel-ended, the activation of cutting or scraping can include a scooping and dumping series of motions. Other cutting or scraping portions of fingers 800 can include needle-ended, bone chisel-ended and safety wire-ended (braided wire-ended) (not shown).

In use, actuating cutting or scraping using fingers 800 can include impacting a finger 800 cutting or scraping portion upon a structure in a subject. Impacting the structure can be achieved using a chiseling, jack hammering motion (e.g., translation along the y axis) or twisting motion (e.g., rotation in the x-z direction).

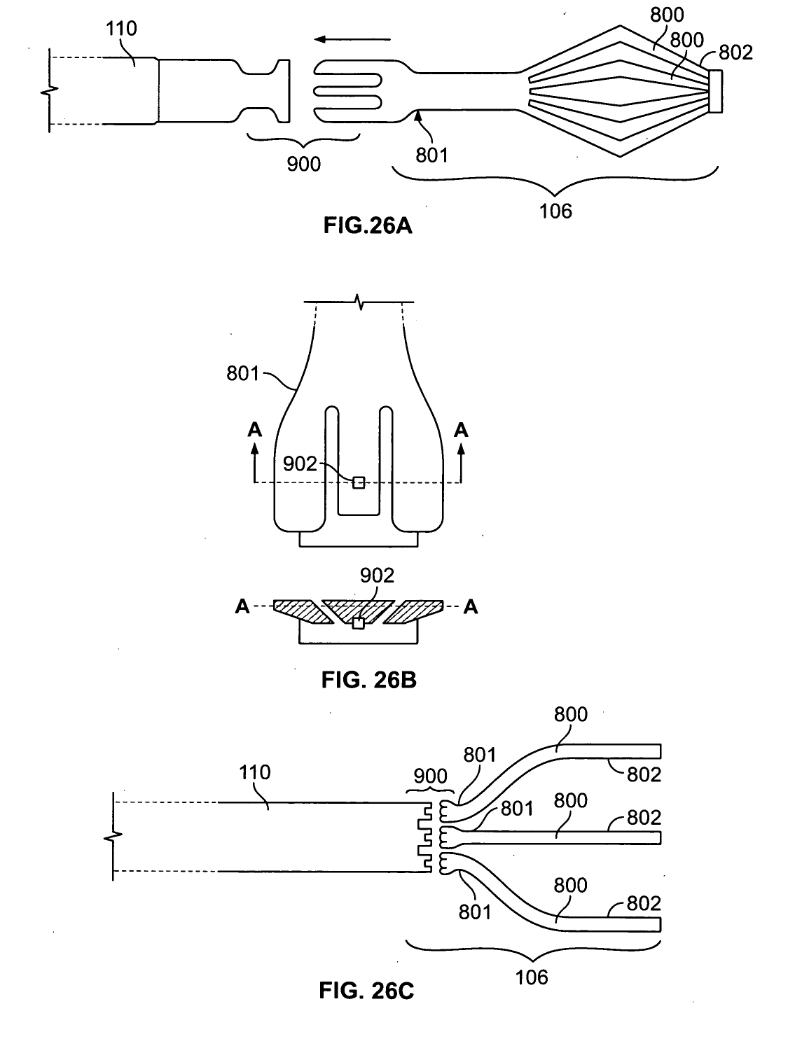

As shown in FIGS. 26A-C, in one implementation, the curette head 106 is detachable from the distal end of the pushrod 110. FIG. 26A shows one implementation where multiple fingers 800 can be interconnected to the pushrod 110 as a unit using a coupler 900. The coupler 900 includes a shaped elongate member distal portion and complementary-shaped finger proximal portion 901. In this implementation, the shape of elongate member distal portion and complementary shape of finger proximal portion 901 can be any of a number of configurations including but not limited to, for example, snap-in, clip-in, press-fit or other suitable detachable interconnection. FIG. 26C shows another implementation wherein the individual fingers 800 can be interconnected to the distal end of the pushrod 110 using a couplers 900. In this implementation, the coupler 900 also includes an elongate member distal portion and complimentary-shaped finger proximal portion 901.

As shown in FIG. 26B, the coupler 900 can include a detent 902 integrated into a finger proximal portion 801, and a complementary protrusion 901 extending from the elongate member distal portion. In use, the detent 902 and the protrusion 901 can reversibly interconnect when the elongate member distal portion is caused to engage finger proximal portion 801. Alternatively, in another implementation, the detent 902 is integrated into the elongate member distal portion and a protrusion extends from the finger proximal portion 801.

In another implementation, the coupler 900 includes a threaded interconnection between the finger proximal portion 801 and the elongate member distal portion. For example, a threaded nickel-titanium finger proximal portion 801 can be screwed onto a distal portion of a threaded stainless steel pushrod 110.

In another implementation the distal portion of the pushrod can include a keyway into which a finger proximal portion 801 can be interconnected (not shown). The distal portion of the pushrod can further include external threads and a threaded locking means for securing one or more fingers 800 to the pushrod 110.

In further implementations the coupler 900 can include an interconnection arrangement including, for example, crush-pins, snap-fittings, leaf springs, magnetic hex-tips, quick connects, ball detents or crimps (not shown).

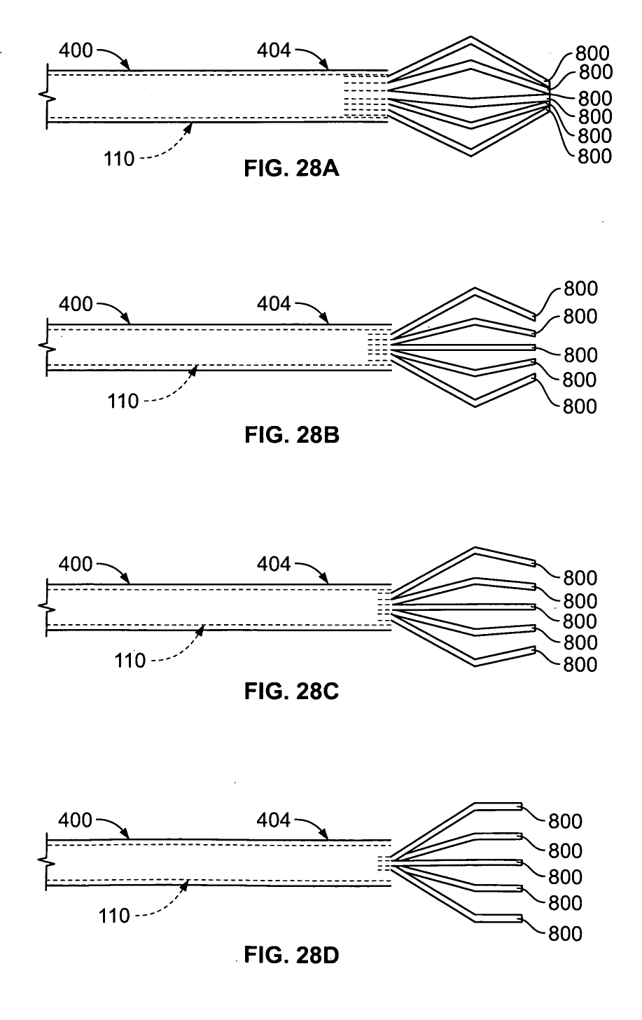

Referring again to FIGS. 24A and C, in one implementation the fingers 800 of the curette tip 114 are reversibly deployable from a substantially co-linear geometry (see FIG. 24C) to a substantially non-co-linear geometry (see FIG. 24A) in relation to the longitudinal axis of pushrod 110. Additionally, as shown in FIGS. 28A-D, in another implementation, the fingers 800 are reversibly deployable from a substantially co-linear geometry (see FIG. 28A) progressively to a substantially non-co-linear geometry (see FIGS. 28B-D) in relation to the longitudinal axis of pushrod 110. In the implementation shown in FIGS. 28A-D, the shaft 400 of the curette system 100 is used to govern the progress of the fingers 800 deployment, based on the elastic nature of the fingers 800 and the degree to which the shaft 400 encloses the fingers 800. As shown in FIGS. 28A-D, when an increased amount of a finger's length is revealed extended from the shaft 400, the finger 800 deploys progressively until maximum deployment occurs (see FIG. 28D). The pushrod 110 is translated in the y direction by squeezing the lever 108 of the handle 102 to extend the fingers 800 from the distal portion 404 of the shaft 400. Deployment of the fingers 800 can be incrementally regulated by translating the pushrod 110 within the shaft 400, to provide degrees of partial deployment (see FIGS. 28A-C) or full deployment (see FIG. 28D). In another implementation, a locking mechanism can be used to allow incremental deployment, for example, at 30°, 60° and/or 90° articulation of the fingers 800.

Deployment of the fingers 800 forming the curette tip 114 can result from inherent properties associated with materials from which fingers 800 are constructed. For example, where the fingers 800 are constructed of a metal, the fingers 800 can deploy to a given pre-formed shape as a result of the spring-like nature of the metal. Alternatively, wherein the fingers 800 are constructed from a shape-memory metal (e.g. NITINOL) the deployment of fingers 800 can be regulated using temperature variation.

In use, after accessing a structure, the cutting or scraping portions of the fingers 800 can be used to create a void within the structure, or to cut, scrape or score the bone, i.e., bone disruption (where disrupted bone is not necessarily removed). As used herein, “create a void” is meant to include both expanding an existing void in a skeletal support structure in addition to expanding the interior of a skeletal support structure to produce a void. It is contemplated that a skeletal support structure accessed with the curette system 100 can include a void prior to being accessed or upon being accessed. It is further contemplated that such a prior existing or contemporaneously formed void can be further expanded using the curette tip 114

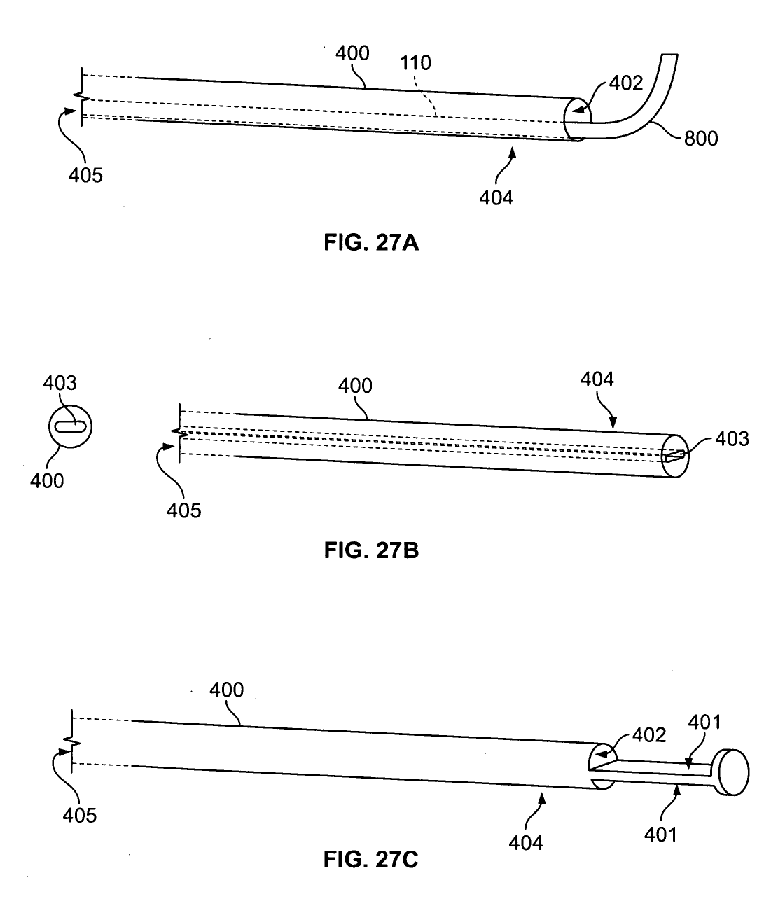

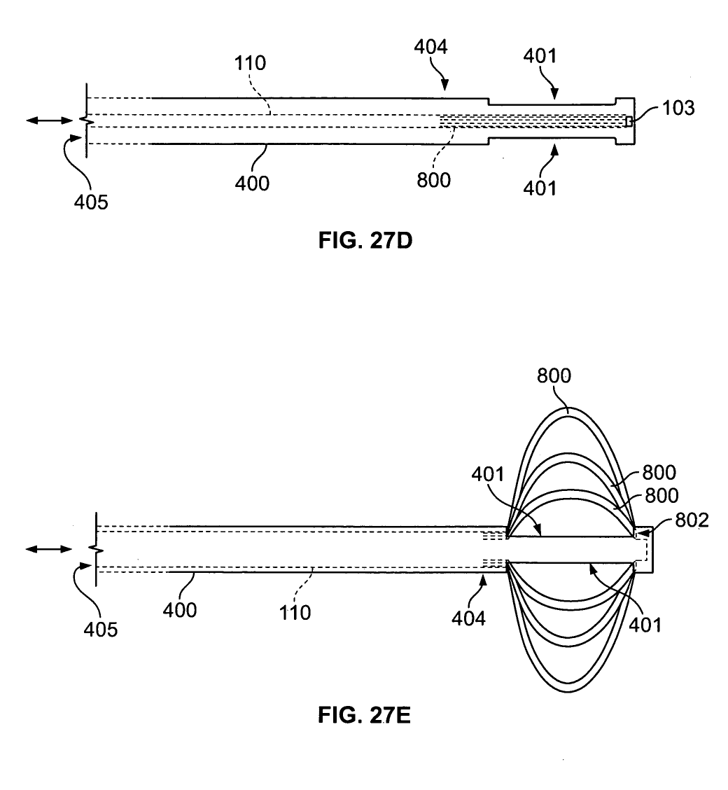

Referring now to FIGS. 27A-E, various configurations of the shaft 400 can be used in conjunction with the pushrod 110 and various configurations of the curette head 106. Exemplary configurations of the shaft 400 can include, but are not limited to, a tubular shaft 400 (see FIG. 27A), a shaft 400 having an oblong cross-section interior lumen 403 (see FIG. 27B), or a shaft 400 having one or more apertures 401 located in the shaft distal portion 404 (see FIGS. 27C-E). Referring particularly to FIG. 27B, in this implementation the shaft 400 includes an oblong cross-section interior lumen 403. When such a shaft 400 is used in combination with a pushrod 110 having a complementary geometry, the interior lumen 403 can function to orient movement of the pushrod 110, and therefore the curette head 106, in a plane, such that in use, cutting or scraping with the curette head 106 in a given plane can be controlled to resist torsion.

Referring particularly to FIGS. 27C-E, in one implementation the shaft 400 includes a proximal portion 405, a distal portion 404 and one or more apertures 401. The apertures 401 provide an egress and re-entry route for the fingers 800 of the curette tip 114 from the shaft's interior lumen 402. The shaft 400 can include any number of apertures 401, for example, a single aperture 401 or two or more apertures 401. The apertures 401 can be arranged in any of a number of configurations, including but not limited to slot(s), hole(s), or the like. As shown in FIGS. 27D-E, a combination of the pushrod 110 with the curette head 106 and the shaft 400, including one or more apertures 401, can be configured and arranged for delivering and deploying the curette head 106 to a structure

As shown in FIGS. 27D-E, the shaft's distal portion 404 is arranged and configured to arrest movement of the curette tip 114. As shown in FIG. 27E, after the curette tip 114 is arrested, two or more fingers 800 can be caused to reversibly deploy through one or more apertures 401. In use, deployment is achieved when the pushrod 110, with the curette tip 114 positioned at the distal end, is advanced to the shaft's distal portion 404 until movement is arrested (see FIG. 27D). Subsequently, as shown in FIG. 27E, further advancement of the pushrod 110 results in deployment of the fingers 800 through the one or more apertures 401. The amount of advancement of the pushrod 110 within shaft 400 can be used to control deployment of fingers 800; the advancement can be controlled by squeezing the lever 108 of the handle 102 of the curette system 100. Deployment of the fingers 800 can be incrementally regulated by positioning the curette head 106 within the shaft 400, to provide degrees of partial deployment (not shown) or full deployment (see FIG. 27E). The deployment process for the fingers 800 can be reversed, for example, by translating the pushrod 110 in the opposite direction within the shaft 400.

In the preceding implementation the two or more fingers 800 can be formed of a material including but not limited to a metal, a shape memory metal and a polymer. In a particular implementation, the shape memory metal is NITINOL. Additionally, a distal portion 802 of two or more of fingers 800 can be interconnected to one or more other finger distal portion 802. For example, distal portion 802 of two fingers 800 can be interconnected. Similarly, distal portion 802 of three or more fingers 800 can be interconnected (see FIGS. 27D-E). Alternatively, where two fingers 800 are interconnected and a third or more additional finger(s) 800 are included in the curette tip 114, distal portion 802 of the additional finger(s) 800 can be free of connection to any other finger(s) 800 (not shown). It is envisioned that any of a number of combinations of interconnected and unconnected fingers 800 can be included in the curette tip 114. In one implementation a minimum of two fingers 800 are interconnected.

A number of embodiments of the invention have been described. Nevertheless, it will be understood that various modifications may be made without departing from the spirit and scope of the invention. Accordingly, other embodiments are possible.

What is claimed is:

1. An apparatus comprising:
a head, the head being rotatable about a first axis and configured to effectuate a medical procedure;
a pushrod attached at a distal end to the head and configured to translate along a second axis substantially perpendicular to the first axis, where translation of the pushrod along the second axis rotates the head about the first axis;
a handle attached to the proximal end of the pushrod, the handle including:
a base,
a lever coupled at a rotation point on a first end thereof to the base and rotatable at the rotation point about a third axis substantially perpendicular to the second axis, where the lever is coupled at the first end to the pushrod and pivoting the lever about the third axis translates the pushrod along the second axis; and
a locking mechanism configured to lock the lever into one or more locked positions, where each locked position of the lever corresponds to a locked position of the head.

2. The apparatus of claim 1, where the locked positions for the head range from substantially 0 to 90 degrees relative to the second axis.

3. The apparatus of claim 1, where the locking mechanism is included in the handle and comprises:
a ratchet mechanism included within the base; and
a linking member coupled at a first end to the ratchet mechanism and at a second end to a second end of the lever;
where rotation of the lever about the third axis advances the ratchet mechanism into one or more positions and locks the lever into one or more locked positions.

4. The apparatus of claim 3, where the ratchet mechanism comprises:
a latch;
a slide link including one or more teeth, the teeth configured to mate with one or more corresponding grooves included in the latch; and
the latch including one or more grooves configured to mate with the teeth included in the slide link;
where the one or more of the teeth are configured to mate with the one or more grooves in a plurality of positions including an initial position and one or more extended positions, and at least one position corresponds to a locked position of the lever.

5. The apparatus of claim 4, further comprising an extension spring coupled between one end of the slide link and a proximal end of the base, the extension spring loading the teeth against corresponding grooves of the latch.

6. The apparatus of claim 5, where the base further includes a release, the release operable to engage the latch to effectuate release of the latch from the slide link so that the extension spring may reposition the slide link into an alternate position closer to the initial position.

7. The apparatus of claim 1, where the pushrod includes at the distal end a cam for coupling the pushrod to the head.

8. The apparatus of claim 1, where the first axis is substantially perpendicular to the third axis.

9. The apparatus of claim 1, where the first axis is substantially parallel to the third axis.

10. The apparatus of claim 1, where the head comprises:
a tapered trunk; and
a disc attached to a distal end of the tapered trunk, the disc having a dome-shaped upper surface and having a substantially 360 degree cutting surface formed about a circumference of the disc.

11. An apparatus comprising:
a head including one or more cutting portions and attached at a proximal end to a pushrod;
the pushrod attached at a proximal end to a handle, the pushrod configured to translate along a first axis, where translation of the pushrod along the first axis translates the head along the first axis;
the handle including:
a base,
a lever coupled at a rotation point on a first end thereof to the base and rotatable at the rotation point about a second axis substantially perpendicular to the first axis, where the lever is coupled at the first end to the pushrod and pivoting the lever about the second axis translates the pushrod along the first axis; and
a locking mechanism configured to lock the lever into one or more locked positions, where each locked position of the lever corresponds to a locked position of the head.

12. The apparatus of claim 11, where at least a portion of the head is formed from a shape memory material, such that at a first temperature the portion of the head is in a compact position and at a second different temperature the portion of the head deploys to a cutting position and the head is configured to cut upon translation and/or rotation of the pushrod.

13. The apparatus of claim 11, where the head comprises a set of three or more fingers and where the one or more cutting portions comprise at least a portion of each of the fingers that is configured for cutting or scraping.

14. The apparatus of claim 13, where each finger includes a proximal and distal end and the distal ends of at least two of the fingers are interconnected.

15. The apparatus of claim 13, where at least one finger is not interconnected at the finger's distal end to another finger.

16. The apparatus of claim 13, where the cutting portion of at least one of the three or more fingers comprises a portion having a configuration selected from the group consisting of: round coin-ended, rectangular coin-ended, curve-ended, multiple curve-ended, turn-ended, flattened coil-ended, flattened loop-ended, bent and coin-ended, coil-ended, bent coil-ended, hour glass coil-ended, osteotome-ended, whisk-ended, barb-ended, multiple curve-ended, hook-ended, sharp-ended, hair pin loop ended, bent-ended, press fit-ended, sickle ended, curved cannula-ended, crown-ended, mace-ended, helicopter ended, crisscross-ended, shovel-ended and multi-windowed tube-ended.

17. The apparatus of claim 13, where translating the pushrod deploys the three or more fingers from a substantially collinear geometry to a substantially non-collinear geometry in relation to the first axis.

18. A method comprising:
establishing an access path to a location in a patient's body;
introducing a head of a medical device through the access path to the location, the medical device comprising:
the head, the head being rotatable about a first axis and configured to effectuate a medical procedure;
a pushrod attached at a distal end to the head and attached at a proximal end to a handle, the pushrod configured to translate along a second axis substantially perpendicular to the first axis, where translation of the pushrod along the second axis rotates the head about the first axis;
the handle including:
a base,
a lever coupled at a rotation point on a first end thereof to the base and rotatable at the rotation point about a third axis substantially perpendicular to the second axis, where the lever is coupled at the first end to the pushrod and pivoting the lever about the third axis translates the pushrod along the second axis; and
a locking mechanism configured to lock the lever into one or more locked positions, where each locked position of the lever corresponds to a locked position of the head; and
pivoting the lever about the third axis to translate the pushrod along the second axis thereby rotating the head about the first axis from an initial position substantially collinear to the pushrod to an expanded position non-collinear to the pushrod.

19. The method of claim 18, where establishing an access path to the location comprises inserting a cannula into the patient to the location, the cannula including a lumen configured to receive the medical device.

20. The method of claim 18, where the head includes a cutting portion, further comprising:
engaging the locking mechanism to lock the position of the head in the expanded position; and
moving the medical device so as to employ the cutting portion of the head within the location of the patient's body to enlarge an existing cavity or to create a cavity.

21. The method of claim 20, where moving the medical device comprises turning, pulling and/or pushing the medical device relative to the patient's body, thereby turning, pulling and/or pushing the cutting portion of the head within the location of the patient's body.

22. The method of claim 18, further comprising:
disengaging the locking mechanism;
pivoting the lever about the third axis to translate the pushrod along the second axis and thereby rotate the head about the first axis to the initial position substantially collinear with the pushrod; and
withdrawing the medical device through the access path from the patient's body.
